(19) United States
(12) Patent Application Publication
(10) Pub. No.: US 2026/0156111 A1
(43) Pub. Date: Jun. 4, 2026

(54) SEAMLESS MULTI-DEVICE WI-FI AUTHENTICATION SYSTEM FOR HOSPITALITY NETWORKS

(71) Applicant: Adeia Guides Inc., San Jose, CA (US)

(72) Inventors: Ning Xu, Irvine, CA (US); Zhiyun Li, Kenmore, WA (US)

(21) Appl. No.: 18/966,479

(22) Filed: Dec. 3, 2024

(51) Int. Cl. H04L 9/40

(52) U.S. Cl. CPC H04L 63/0876; H04L 63/101

(57) ABSTRACT

Systems and methods for managing resources when authenticating devices with an internet access system are described. An example method includes authenticating, by an internet access system, a first device of a plurality of devices. The method then includes receiving, by the internet access system, from the first device of the plurality of devices, a device list comprising a respective device ID for each of the plurality of devices. The method then includes, based at least in part on the internet access system receiving a request to access the internet access system from a second device of the plurality of devices, automatically authenticating the second device with the internet access system using the received device list before receiving additional input from the second device.

### FIELD OF INVENTION

The present disclosure relates to managing resources within the context of a user staying at short term lodging (e.g., a hotel), by enabling seamless authentication of multiple devices with an internet access system.

### SUMMARY

When staying at a hotel or other temporary lodging, guests typically need to log in to the Wi-Fi network individually for each of their devices. This process can be cumbersome, especially for users with multiple devices such as smartphones, tablets, laptops, and smartwatches. The repeated login process may not only be time-consuming but can also be frustrating if the login credentials and or processes are long or complex.

Within this context, the distinct but related concepts of identification, authentication, and authorization may be relevant. Identification may refer to the act of claiming an identity, such as by a device providing a username or account number. Authentication may then refer to the process of proving the device's identity, such as by entering a password, passphrase, or PIN. Authorization then refers to the process of determining what actions or resources the device can access after its identity has been established and/or authenticated.

In one approach, after one device is logged to a Hotel Wi-Fi for example, the Wi-Fi password may be shared between nearby devices to make the log in process by subsequent devices easier. For example, Google's Nearby Share allows Android devices to securely exchange network information without manual entry. Apple's iOS also enables passwords to be shared between Apple devices. However, to share passwords both devices must be signed into iCloud with the email address of the other user saved in their contacts. Further, to share between Android and Apple devices, a QR code may be generated to enable users to scan and automatically connect to the network. This approach of sharing the password between devices can still be inconvenient, requiring additional steps for each device. Additionally, this approach may not work where devices are not compatible with each other, and/or where there is varying support for this functionality across different devices and platforms.

In another approach, Wi-Fi captive portal solutions are used to manage the authentication of devices trying to connect to the network. When a user connects their device to a Wi-Fi network, they are redirected to a web page (e.g., the captive portal) where they must authenticate, often by entering credentials, agreeing to terms, or inputting a voucher code, etc. Multi-device Single Sign-On (SSO) is an approach that enables a user to sign on with a primary device. Once the user authenticates the primary device, other devices belonging to the same user can connect to the network without needing to authenticate separately. To make Multi-Device SSO work, however, the captive portal needs to generate a session token associated with the user's account. The token will then be stored on the primary device and shared with other devices, which will present the token to the captive portal during the authentication process. In the Multi-Device SSO approach, the user must set up a user account with the captive portal, and the token must be shared from the primary device to the additional devices. This approach therefore requires additional configuration steps, which may not be intuitive for the user.

With these drawbacks in mind, examples of the present disclosure enable a simplified and streamlined authentication process for multiple devices with an internet access system. Embodiments disclosed herein provide secure authentication of multiple devices, use fewer resources by automatically authenticating a user's devices, and provide an approach to authentication of multiple devices that is less prone to human error. In some embodiments, such as where many users are attempting to authenticate at the same time, the processes described herein may be spread out over time, enabling more efficient use of resources as well.

The embodiments disclosed herein may provide the benefit of enabling automatic authentication of multiple devices by authenticating a first device. Once the first device is authenticated, additional devices may be automatically authenticated, using, for example, a previously generated “device list,” without the need for additional input from the user and/or the additional device itself. As a result, there may be no need to set up an account like in the case of Multi-Device SSO, or to share a token between devices. Additionally, embodiments of this disclosure may enable pre-authentication of one or more devices via a booking confirmation email prior to the user's stay at the temporary lodging. Further, embodiments may enable grouping of devices within the list, enabling the user to easily manage which devices should be authenticated or authorized, as well as the conditions under which the various groups should be authenticated or authorized (e.g., allowing the user to designate and edit a family device group, work device group, etc.).

In an embodiment, an example method includes authenticating, by an internet access system, a first device of a plurality of devices. Generally speaking, an internet access system is a Wi-Fi network of a hotel, rental property, business, or other entity. The internet access system may enable a user to connect to the internet once logged in. The method may include receiving, by the internet access system, from the first device of the plurality of devices, a device list comprising a respective device ID for each of the plurality of devices. In some embodiments, this “device list” may be thought of as a list of devices to be transferred to the internet access system for authentication of the listed devices at or around the same time the user authenticates the first device, thereby freeing the user from the need to individually authenticate each of his other devices as he uses them.

The method may further include, based at least in part on the internet access system receiving a request to access the internet access system from a second device of the plurality of devices (e.g., one of the devices on the device list), automatically authenticating the second device with the internet access system using the received device list, before receiving additional input from the second device. That is, when the second device attempts to access the internet via the internet access system, the second device does not have to provide any log in information (e.g., in contrast to the first device), and may simply proceed as though the log in information was already provided and the second device has been authenticated.

In some embodiments, the plurality of devices may comprise a device group. Because a user may have or may be associated with many devices (e.g., work phone, personal phone, family member phones), the devices may be grouped into device groups. For example, there may be a work device group that include the user's work phone, personal phone, and work laptop, while a family device group includes the personal phone and one or more family member phones, tablets, and laptops. In some embodiments, the method further comprises causing a prompt to be presented via a user interface of the first device, the prompt enabling the user to select one or more selected devices, and then establish a device group based on the selection of the one or more selected devices. This enables the user to determine which of the many possible devices should be automatically authenticated, and which should not. In some embodiments, a device group may be established automatically based on determining that two or more devices are each connected to the same network. For example, at a user's home, if multiple devices are each connected to the home Wi-Fi network they may all be included in a home device group. Similarly, at a user's work, if multiple of the user's device are each connected to the work Wi-Fi network, they may all be included in a work device group. Note that not all devices connected to the same network may be visible to each other. However, in some cases the router or another device may have complete information about all connected devices, which may enable devices to be joined to the same device group even if they are not initially visible to each other.

In some embodiments, the device list and/or device group may be stored in a cloud storage. Generally speaking, the phrase cloud storage refers to non-local storage of the device list and/or device groups on the first device or other user devices. In the event the first device is lost or otherwise unavailable, the internet access system may request the device list and/or device group from the cloud storage, to enable automatic authentication of the user's device(s).

In some embodiments, the method further includes, after authenticating the first device of the plurality of devices with the internet access system, causing to be provided via a user interface of the first device, a prompt enabling selection of the second device (or multiple second devices) of the plurality of devices. This may allow the user to select particular devices from the device list for which the user wants to enable automatic authentication. In some events, the user may wish only for certain devices on the device list to be automatically authenticated, and may select particular devices while not selecting others. The method then includes, based on receiving the selection of the second device(s) of the plurality of devices, storing, at the internet access system, the device ID of the second device(s). While the device list may include all of the possible devices and device IDs, if the user selects only a subset of devices, only that subset's device ID's may be stored by the internet access systems, and only that subset may have automatic authentication. In some examples, the method further includes, based on receiving the selection of the second device(s) of the plurality of devices, automatically authenticating the second device(s) with the internet access system before receiving additional input from the second device(s). Additionally, based on receiving the selection of the second device(s), the selected devices may be set as a default selection for use the next time the user joins the network, or joins a different network at a new location.

In some embodiments, once the internet access system authenticates the first device, the first device may identify other proximate devices that should be automatically authenticated by the internet access system. For example, the first device may search the area for additional devices using Bluetooth or some other short range wireless communication, in order to identify from the list of possible second devices only the subset that is actually located within proximity of the first device. Once identified using the short range wireless communication, the set of second devices'IDs may then be stored at the internet access system to enable automatic authentication of that set of second devices.

In some embodiments, the plurality of devices comprises a first device group (e.g., home group, work group, etc.). The method further includes causing to be provided via a user interface of the first device, a prompt enabling selection of a second device group of a plurality of device groups. The method then includes, based on receiving the selection of the second device group, storing, at the internet access system, the respective device IDs of each device of the second device group. This may occur when the first device is part of multiple device groups (e.g., the user's personal phone may be part of both the home group and the work group). When the user logs in to the internet access system with their personal phone, it may be unclear whether the user intends to automatically authenticate devices that are part of the home group, the work group, or both. By providing a prompt to enable the user to select the particular group, the internet access system may be able to identify the proper set of devices for which to store the device IDs and enable automatic authentication.

In some embodiments, the method further includes, before authenticating the first device, transmitting a message associated with the internet access system to the first device. The message may comprise a selectable option to pre-authenticate a connection of the first device to the internet access system. The message may be sent along with a booking confirmation email, enabling the user to perform the steps of authentication with the hotel Wi-Fi from their home, prior to arrival at the hotel itself. The method then includes pre-authenticating the first device of the plurality of devices (and/or one or more other device) with the internet access system based on receiving a selection of the selectable option. The message may comprise a booking email corresponding to a future period of time for which a user associated with the first device is booked to stay at a temporary lodging. In this case, the method further includes, based on receiving the selection of the selectable option, storing the device ID corresponding to the first device (and/or the one or more second devices) by the internet access system. In some embodiments, one or more devices, device IDs, device groups, and/or other sets or subsets of device may be stored and preset for frequent travelers, particularly those that may return to the same hotel for multiple different trips.

In some embodiments, the method may further include identifying an authentication period based on the message associated with the internet access system (e.g., sent by the hotel or other temporary lodging), wherein the authentication period corresponds to a future time period for which a user associated with the first device is booked to stay. The method may then include, based on receiving the selection of the selectable option, pre-authenticating the first device of the device group (and/or one or more second devices) with the internet access system such that the first device (and/or sone or more second devices) is enabled to access the internet access system at a beginning of the authentication period, and is disabled from accessing the internet access system at an end of the authentication period.

In some embodiments, the method may include storing the device list comprising the respective device IDs of all of the plurality of devices in an encrypted format.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 illustrates a simplified diagram showing multiple devices being joined to a device group, a first device being authenticated at an internet access system, and a plurality of second devices being automatically authenticated at the internet access point, in accordance with some embodiments of the disclosure;

FIG. 2 illustrates a sequence diagram showing an example process for joining two devices to a device group, in accordance with some examples of the disclosure;

FIG. 3 illustrates a sequence diagram showing an example process for automatically authenticating multiple devices at an internet access system, in accordance with some examples of the disclosure;

FIG. 4 illustrates a sequence diagram showing an example process for pre-authenticating a device with the internet access system, in accordance with some examples of the disclosure;

FIG. 5 illustrates a sequence diagram showing an example process for authenticating a first device at the internet access system, identifying additional devices that should be authenticated based on proximity to the first device, and authenticating the additional devices, in accordance with some examples of the disclosure;

FIG. 6A depicts a system for carrying out various functions described herein, in accordance with some embodiments of the disclosure;

FIG. 6B depicts computing device of the system shown in FIG. 6A, in accordance with some embodiments of the disclosure;

FIG. 7 depicts an example system, in accordance with some embodiments of the disclosure; and

FIG. 8 illustrates an example flowchart showing a process of automatically authenticating a device with an internet access system, in accordance with some embodiments of the disclosure.

### DETAILED DESCRIPTION

As noted above, embodiments of the disclosure relate to providing automatic authentication of devices with an internet access system, such as for a Wi-Fi network in a hotel, business, or other location. Methods and systems disclosed herein leverage automatic device registration to one or more device groups and automatic authentication of devices once a first device of the device group is authenticated with the internet access system.

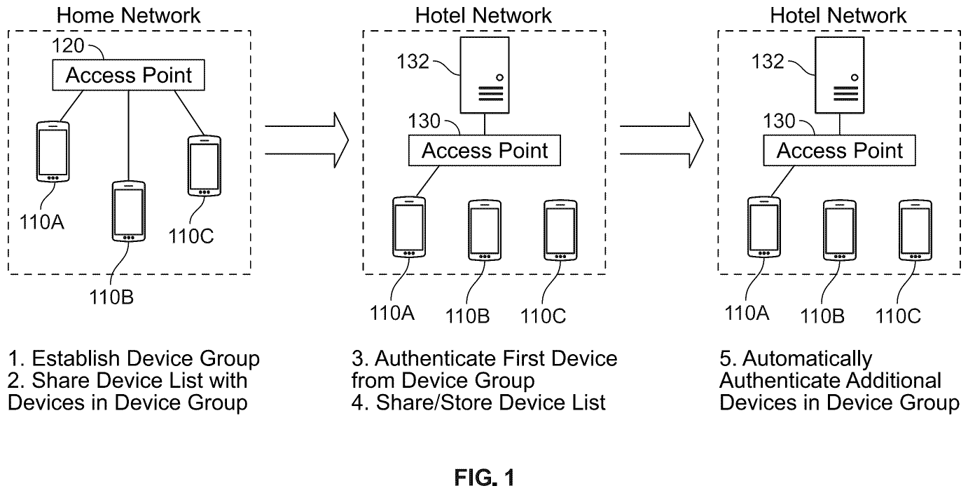

FIG. 1 illustrates an overview of an example process for automatically authenticating devices at an internet access system. As shown in FIG. 1, an initial step (e.g., step 1) may include establishing a device group comprising one or more devices (e.g., devices 110A, 110B, and 110C). In an example, devices 110A-C may each be present at a user's home, and may all be connected to the home network 120. Each device 110A-C connected to the user's home network may automatically register and share its unique identifier with other connected devices, creating a synchronized device list of known devices in the device group (e.g., step 2). The device list may be shared across devices in the device group, such that each device includes the list of all the other devices in the device group.

When the user travels to a new location (e.g., a hotel), the user may connect their first device (e.g. device 110A) using a typical procedure. For instance, the user may access the hotel internet access system comprising and access point 130 and one or more servers 132 by connecting to the hotel Wi-Fi via the access point 130. The user may follow typical procedures to authenticate the first device, such as by entering a password or other information. This is shown as step 3 in FIG. 1.

After connecting the first device 110A with the internet access system of the hotel, the first device 110A may share a device list with the internet access system. The device list may comprise a list of identifiers of devices in the device group established at step 1, and/or may include one or more identifiers of other devices or device groups associated with the first device 110A. At step 4, the device list may be shared with the internet access system, and may be stored by the one or more servers 132.

In some embodiments, upon authenticating the first device 110A, the first device may be configured to present a prompt to the user, enabling the user to select one or more devices or device groups. The identifiers of the selected device(s) or device group(s) may then be shared with the internet access system, and/or may be stored by the one or more servers 132.

At step 5, one or more of the additional or second devices (e.g., devices 110B and/or 110C) may attempt to access the internet access system. Because the identifiers of devices 110B and 110C were shared by the first device 110A and stored by the one or more servers 132, devices 110B and 110C are automatically authenticated. The internet access system may receive the identifiers of devices 110B and 110C when they attempt to connect, and may compare those identifiers to the stored list of devices provided by the first device 110A. As a result, devices 110B and 110C do not need to follow the typical authentication process (e.g., inputting a password or other credentials), and are instead automatically authenticated without further input. Devices 110B and 110C are then authenticated, and can access the internet via the internet access system.

This process significantly simplifies the connecting multiple devices to the hotel Wi-Fi, thereby reducing resource usage and reducing the chance of user error in performing authentication. Additionally, this process eliminates the need for manual Wi-Fi authentication processes for each device, providing a streamlined and efficient way to manage multiple device connections in a hotel environment. Additional details and examples are provided with respect to the FIGS. described below.

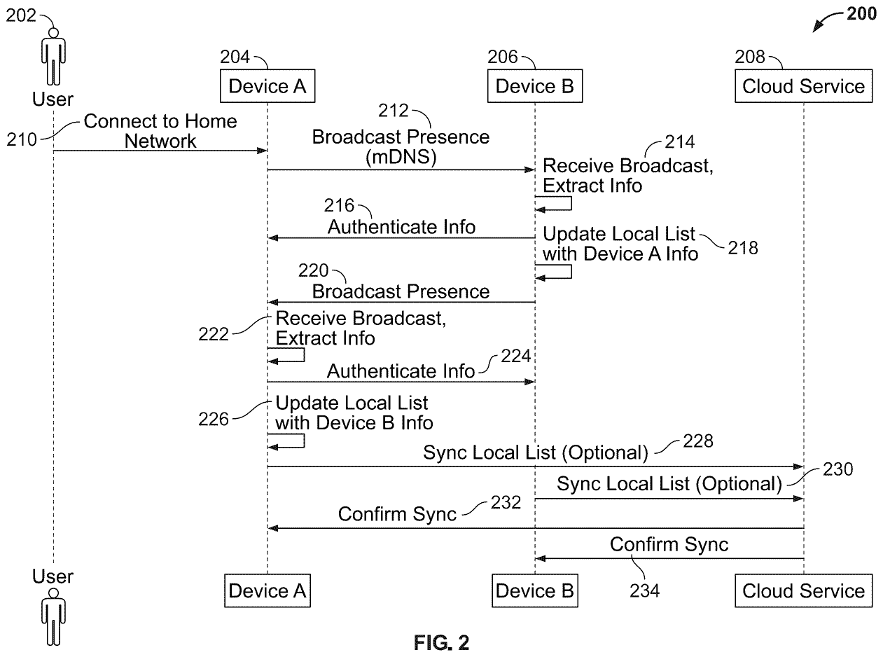

FIG. 2 illustrates a sequence diagram 200 showing how two devices (e.g., devices 204 and 206) register each other into a device group, as well as how the device group (or device list) can be stored in a cloud storage 208 to allow the list to be accessed outside the home network used to establish the device group. In the example illustrated in FIG. 2, devices 204 and 206 are automatically registered with each other based on their connection to the same network at the same time. In other embodiments, described in further detail below, devices may be joined to a device group based on selection by a user (such as in response to a prompt displayed on a user device).

At step 210, the user 202 connects their device (e.g., device 204) to the home network. This may include the device 204 automatically registering itself on the home network using local network discovery protocols such as Multicast DNS (mDNS) or Bonjour. The second device 206 may also automatically register itself on the home network, in the same manner as the first device 204. Each device (e.g., devices 204 and 206) may periodically broadcast its presence on the network, including the device's unique identifier (e.g., MAC address) as well as a human-readable name (e.g., Kevin's iPhone). Other devices on the network listen for these broadcasts and update their internal list of known devices. This exchange ensures that each device has an up-to-date list of all devices in the network. The list may be stored locally on each device in an encrypted format to ensure security and privacy.

At step 212 of FIG. 2, the first device 204 broadcasts its presence on the network. The second device 206 receives the broadcast, and at step 214 extracts the relevant information (e.g., the unique device ID and human-readable name of device 204). At step 216, the second device authenticates the extracted information of the first device 204, and then at step 218 the second device updates its locally stored list of devices with the first device 204 information.

At steps 220-226, the same process as steps 212-218 is repeated but in the opposite direction. That is, the second device 206 broadcasts its presence, and the first device 204 receives the broadcast and extracts the relevant information (e.g., the unique device ID and human-readable name of device 206). Device 204 then authenticates the extracted information and updates its locally stored list of devices with the second device 206 information.

At steps 228-234, in some embodiments, the list of devices is stored in a cloud storage and synchronized between devices 204, 206, and the cloud service 208. At steps 228 and 230, device 204 and 206 each send their device lists to the cloud service (or cloud storage) 208. At steps 232 and 234, the cloud service (or cloud storage) 208 returns a confirmation message confirming the synchronization of the device list. As a result, device 204, device 206, and the cloud service (or cloud storage) 208 all have the same synchronized list of devices.

In some embodiments, rather than automatically joining all devices connected to a network to the same device list, a prompt may be presented via one or more of the connected devices enabling a selection of one or more other devices. The device list (e.g., the list of all devices) or the device group (e.g., a subset of devices on the device list) may then be established based on the selection of devices. For instance, when the first device 204 is connected to the home network at step 210, the first device 204 may present a user interface to enable the user 202 to select one or more additional devices to join to the device list or a given device group.

The first device 204 may first retrieve the list of known devices from its local storage or the cloud service 208 and may then display a user interface listing all the known devices. The UI may then enable the user to select or deselect devices.

In some embodiments, particularly with respect to steps 212-218 and 220-226, wherein the devices broadcast and authenticate with each other to generate the device list, the devices may share their unique identifiers and human-readable names securely using encryption (e.g., TLS). When a device joins the home network, it may send out a discovery packet containing its unique identifier and name. Upon receiving a discovery packet, each other device may authenticate the sender device using a pre-shared secret or public key infrastructure (PKI) to ensure data integrity. The authenticated information may then be added to the local list of known devices stored on each device (and/or in the cloud storage 208).

Steps 228-234, wherein the device list is synchronized and stored in the cloud storage 208, may be optional. The synchronized list of known devices can optionally be backed up to a cloud service 208 to ensure accessibility by devices outside the home network. Devices may periodically synchronize their locally stored list with the cloud service 208 list using secure channels (e.g., HTTPS). The data may be encrypted before transmission to protect it from interception during transit and stored in an encrypted format on the cloud service 208 to ensure it remains secure.

All communications between devices (e.g., device 204 and 206), the cloud service 208, and the hotel internet access system (described below) may be encrypted using strong encryption methods such as TLS/SSL. This may ensure data privacy and security during transmission. Device identifiers and authentication tokens may be stored securely on the hotel server of the internet access system using encryption at rest. This may protect the data from unauthorized access and ensure that even if the server is compromised, the data remains secure.

In some embodiments, the system may implement robust authentication protocols to ensure only authorized devices can connect to the network. This may include multi-factor authentication (MFA) for cloud services and secure, time-limited tokens for device authentication.

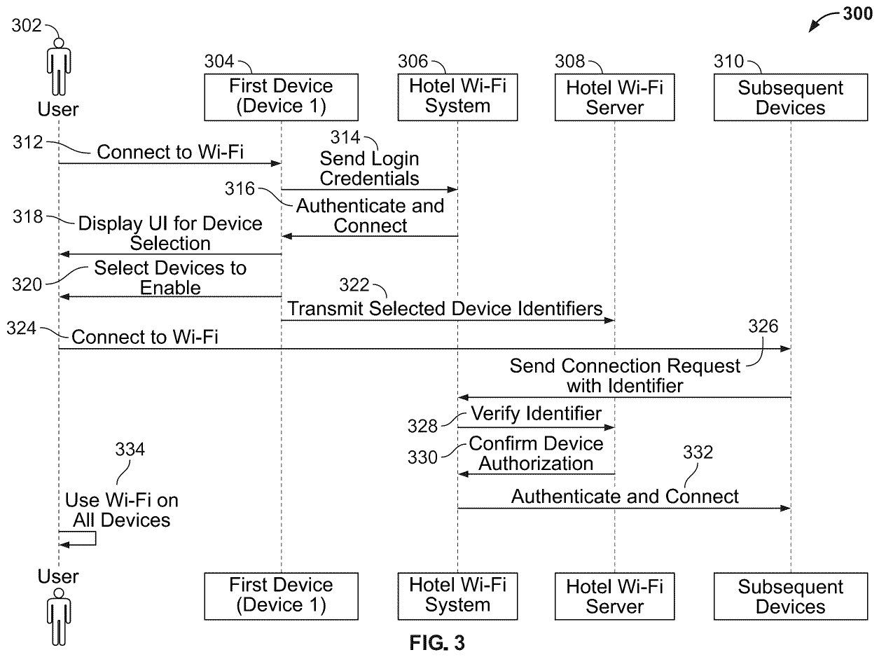

FIG. 3 illustrates a sequence diagram 300 showing the process of automatically authenticating a user's devices at a hotel internet access system after authentication of a first device. FIG. 3 illustrates communications between a first device 304, a hotel internet access system comprising a Wi-Fi system 306 and a Wi-Fi server 308, and one or more subsequent devices 310.

At step 312, the user 302 connects a first device 304 to the hotel Wi-Fi system 306. This may include selecting the hotel Wi-Fi SSID from a list of possible networks. At steps 314 and 316, the first device 304 transmits login credentials, and the hotel Wi-Fi system 306 authenticates and connects the first device 304 to the internet. This may be referred to as an authentication process, which may in some embodiments be conducted via a captive portal or a password entry. The first device 304 may verify its identity with the hotel Wi-Fi system 306 using standard authentication protocols.

At step 318, in some embodiments, the first user device may present a user interface allowing the user to select one or more additional devices (e.g., subsequent devices 310) from a pre-registered list (e.g., the device list discussed above with respect to FIG. 2). Then at step 320, the first device 304 may receive a selection of one or more individual subsequent devices, one or more groups of devices (e.g., home group, work group, etc.), one or more networks for which a device group was established (e.g., a group established via a home network, work network, public network, etc.), and/or a selection of all devices on the device list stored by the first device 304. The first device may present a user interface listing all the possible devices, or only a subset of devices, in any suitable arrangement.

In some embodiments, the user interface may enable the selection of a device group and/or network for which a device group or device list has been established (e.g., home network, work network, public network, etc.). Each local network may have a corresponding known device list associated with it, and the hotel internet access system (e.g., Wi-Fi system 306 and/or server 308) may cause the first device 304 to prompt the user through multiple layers of selection. The first layer may allow the user to select the local network (e.g., home, work, public, etc.) they are connecting from or for which a device group was established. Once the local network is selected, the user can then proceed to select devices within the known list of that network (e.g., selecting only certain devices from a given device group). This process may enable a more organized and intuitive selection process, ensuring that only relevant devices from a particular device group are displayed for authentication with the hotel internet access system. Additionally, devices can distinguish between home networks, work networks, and other public networks by recognizing unique network identifiers or configurations. In some embodiments, only devices joined to a device group via a home network may be added to the list for hotel Wi-Fi access, further enhancing security and personalization. This feature allows the systems and methods of the disclosure to efficiently manage which devices are authorized for network access based on the context of the local network, ensuring a streamlined and secure connection process.

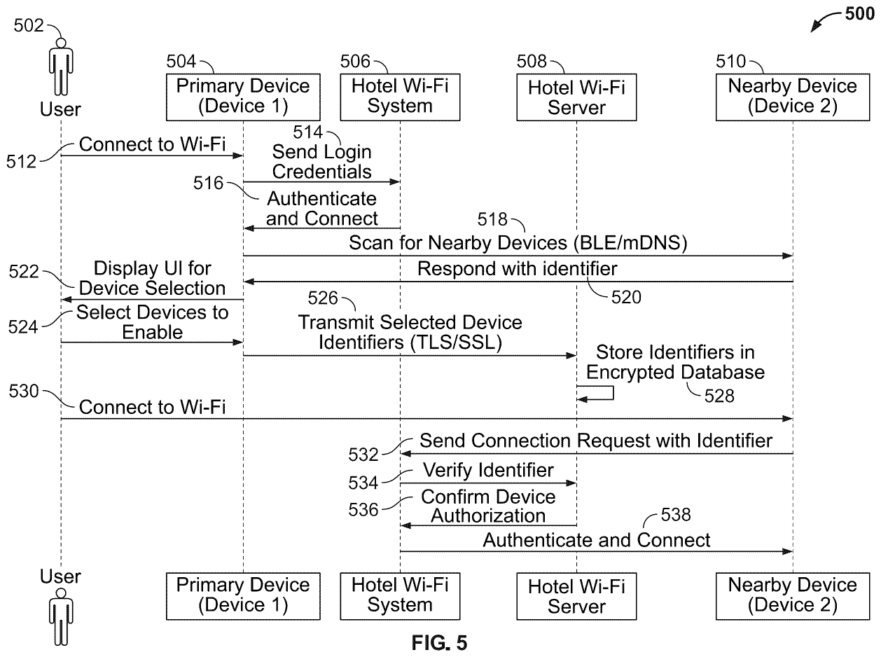

In some examples, the subsequent devices 310 may be identified based on proximity to the first device 304. For example, before or after authenticating the first device 304 with the internet access system at step 316, the first device may determine one or more subsequent or second devices that should be included based on short range wireless communication between the first device 304 and the one or more subsequent devices 310. This process is described in more detail below, with respect to FIG. 5.

At step 322, the selected subsequent devices are transmitted to the internet access system, and in particular to the hotel Wi-Fi server 308. The hotel Wi-Fi server 308 may then store the received list of devices.

At step 324, the user 302 attempts to access the internet via the internet access system using the one or more subsequent devices included in the list transmitted to the hotel Wi-Fi server 308 at step 322. If the first device 304 is the user's personal phone, the subsequent devices may include the user's laptop, other phone(s), tablets, smart watch, etc.

At steps 326-332, the subsequent device(s) 310 transmit connection requests to the hotel Wi-Fi system 306, and the hotel Wi-Fi system 306 verifies the identifier of the subsequent device(s) 310, confirms the authorization of the subsequent device(s) 310, and automatically authenticates the subsequent device(s) 310. When one or more subsequent device(s) 310 attempt to connect to the hotel Wi-Fi system 306, each subsequent device sends a connection request along with its unique identifier. The hotel Wi-Fi server 308 receives the connection request and checks the received unique identifier against the stored list of authorized devices (e.g., the list provided by the first device 304 at step 322). If the received identifier from the subsequent device matches an entry on the stored list, the server 308 authenticates the subsequent device and grants access to the network. Steps 326-332, and in particular the automatic authentication of the subsequent devices after the request to connect is transmitted by the subsequent device(s) 310, may occur without any additional input from the subsequent device(s) 310. That is, the user need not input any password or other credentials via the subsequent devices. At step 334, after the automatic authentication of the subsequent device(s) 310, the user may access the internet via the internet access system on the first device 304 as well as each of the subsequent device(s) 310.

After the user selects the additional devices to enable (e.g., step 320), the selected device identifiers may be securely transmitted to the hotel Wi-Fi server 308 using encryption protocols like TLS/SSL. The hotel Wi-Fi server 308 may receive the encrypted data and store the identifiers of the selected devices in a secure, encrypted database. The server 308 may ensure that this data remains protected from unauthorized access. In some embodiments, the stored data including the device identifiers may also include a valid duration (or authentication period) for one or more selected device identifiers. That is, the hotel server 308 may store a valid duration (or authentication period) for which each device may be authenticated with the internet access system. If a current time is before or after the valid duration, the corresponding device may be prevented from accessing the internet via the internet access system or may be prevented from being authenticated by the internet access system.

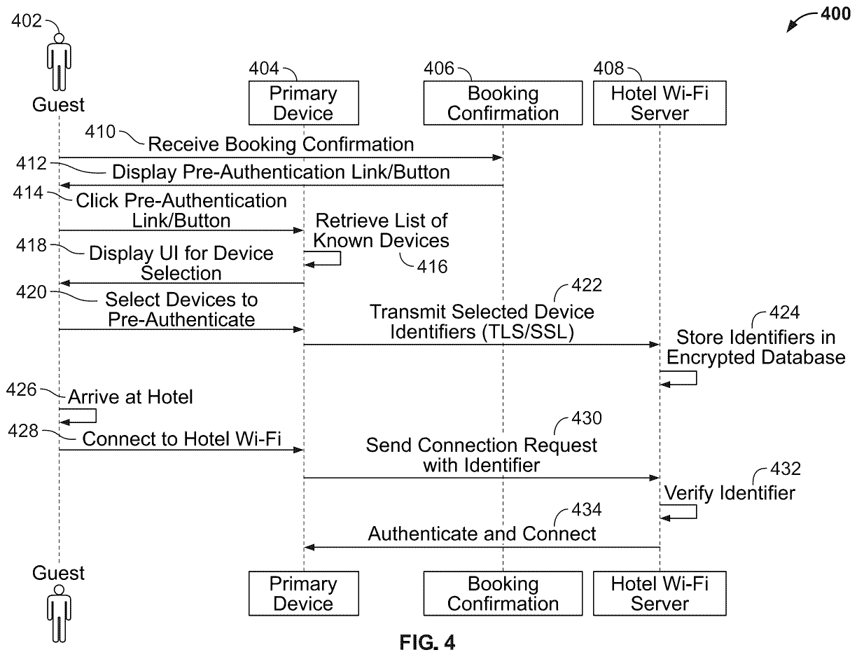

FIG. 4 illustrates a sequence diagram 400 showing an example embodiment wherein a booking confirmation message (e.g., a booking email) is provided to the user (such as via the user device 404), enabling the user to pre-authenticate one or more devices with the internet access system. In one scenario, this may enable a user to pre-authenticate their devices with the hotel Wi-Fi system prior to arriving at the hotel, enabling the user to access the hotel Wi-Fi immediately upon arrival at the hotel for their booked stay.

When a guest (e.g., guest 402) confirms the hotel booking online, or when the guest receives a confirmation email message for their hotel booking, the message may include a link, button, or other user interface element that enables automatic authorization of a list of devices. This process may leverage the known devices already registered on the guest's primary device 404. Upon clicking the button (or interacting with the user interface element), the guest can access an interface where they can view and select from their list of known devices, which have been pre-registered with the primary device 404 and synchronized. The selected devices may then be pre-authenticated for Wi-Fi access at the hotel internet access system. In some embodiment, the valid duration (or authentication period) for which the selected devices are authenticated may be extracted from the hotel booking information. This pre-authentication feature may significantly streamline the connectivity process and ensure that all selected devices are ready to connect as soon as the guest checks in. In some embodiments, the cancelation of the hotel booking may automatically delete the pre-authenticated entries in the system.

FIG. 4 illustrates a guest 402 having a primary device 404, a booking confirmation system 406, and a hotel Wi-Fi server 408 which may be part of the hotel internet access system. At step 410, the guest may retrieve or receive the booking confirmation message detailing the booked stay at the hotel for that user. In some examples, the booking confirmation message may be received by the primary device 404 (e.g., the guest's personal phone), or by some other device (e.g., the guest's laptop or home computer). Step 412 may include displaying the pre-authentication link, button, or other user interface element via the device that received or retrieved the booking confirmation message.

At step 414, the device that received or retrieved the booking confirmation message may receive a selection of the pre-authentication user interface element. This may include the guest selecting to pre-authenticate one or more devices with the hotel internet access system.

At step 416, the first device retrieves a list of known devices. The list may be stored locally by the first device 404 or may be stored in a cloud storage as described above with respect to FIG. 2. At steps 418-420, the receiving device then presents a user interface enabling the guest 402 to select one or more devices to be pre-authenticated. This process may be similar or identical to the process steps 318-320 described above with respect to FIG. 3.

After identifying the selected devices, at step 422 the primary device 404 may transmit the selected device identifiers to the hotel internet access system comprising the hotel Wi-Fi server 408. This communication may be secured and may include using TLS/SSL. At step 424, the hotel Wi-Fi server 408 may store the identifiers received from the primary device 404 in an encrypted database.

Sometime after the pre-authentication process is completed, at step 426 the guest 402 arrives at the hotel. And at step 428, the guest attempts to connect to the hotel internet access system via the primary device 404. The primary device 404 transmits a connection request along with a device identifier to the hotel Wi-Fi server 408 at step 430.

At steps 432-434, the hotel Wi-Fi server 408 verifies, authenticates, and connects the primary device 404 to the internet via the internet access system. These steps are performed without requiring any additional input by the primary device (e.g., the primary device does not need to transmit a password or other credential, which would otherwise be needed to access the internet via the internet access system). That is, the primary device is automatically authenticated at step 434, similar to the automatic authentication of the subsequent device 310 described in steps 326-332 of FIG. 3.

As noted above, in some embodiments there may be a valid duration (or authentication period) associated with the primary device. For example, if a guest books a hotel for two nights, the pre-authentication associated with the guest's device(s) may only be valid during the booked stay. Before the stay begins, and after the stay ends, the pre-authentication may be rendered inactive or deleted, and/or the guest's device(s) may be prevented from being automatically authenticated or accessing the internet access system.

FIG. 5 illustrates a sequence diagram 500 showing an example process for identifying additional devices that should be automatically authenticated by the internet access system, using short range wireless communication. For example, when the user arrives at the hotel and authenticates their primary device (e.g., device 504), the process may include identifying additional devices that should be automatically authenticated with the hotel internet access system without requiring those additional devices to perform any further steps of authentication, such as password or other credential entry.

In some embodiments, the additional devices 510 may be detected based on proximity to the primary device 504. The primary device 504 may detect proximate devices using short range wireless communication, such as Bluetooth Low Energy (BLE) or Multicast DNS (mDNS). When the primary device 504 connects to the hotel Wi-Fi and the user is prompted to select additional devices for network access, the system may scan for nearby devices that are already in the known list stored by the primary device 504 (and/or in a cloud storage). If a known device is detected nearby, the user interface (UI) may highlight this status to the user.

The sequence diagram 500 illustrates a user 502, a primary device 504, the hotel internet access system comprising the hotel Wi-Fi system 506 and hotel Wi-Fi server 508, and one or more proximate ore nearby devices 510. At step 512, the user connects the primary device 504 to the hotel Wi-Fi system 506. At steps 514-516, the primary device transmits login credentials to the Wi-Fi system 508 and is authenticated and connected.

At steps 518-520, the primary device 504 scans for nearby or proximate device 510, using one or more short range wireless communication protocols such as BLE or mDNS. Each proximate device 510 may respond to the primary device 504. BLE is efficient in detecting devices within a short range, typically up to 100 meters, making it suitable for identifying devices in close proximity. This information can also be cross-referenced with the known list of devices stored on the primary device 504 or synchronized from the list stored in cloud storage. Another technique, mDNS, may operate by sending out multicast queries to resolve the names of other devices on the network without requiring a central DNS server.

At step 522, The UI of the primary device 504 may then then indicate which devices are nearby, providing a visual cue, such as a green dot or a. “Online” label next to the device name, enhancing the user's ability to quickly and accurately select the devices to enable for automatic authentication and Wi-Fi access.

At step 524, the primary device 504 may receive a selection of one or more individual subsequent devices, one or more groups of devices (e.g., home group, work group, etc.), one or more networks for which a device group was established (e.g., a group established via a home network, work network, public network, etc.), and/or a selection of all devices on the device list stored by the primary device 504.

At step 526, the selected proximate devices are transmitted to the internet access system, and in particular to the hotel Wi-Fi server 508. The hotel Wi-Fi server 508 may then store the received list of devices in an encrypted database at step 528.

At step 530, the user 502 attempts to access the internet via the internet access system using the one or more proximate devices 510 included in the list transmitted to the hotel Wi-Fi server 508 at step 526.

At steps 532-538, the proximate device(s) 510 transmit connection requests to the hotel Wi-Fi system 506, and the hotel Wi-Fi system 506 verifies the identifier of the proximate device(s) 510, confirms the authorization of the proximate device(s) 510, and automatically authenticates the proximate device(s) 510. When one or more proximate device(s) 510 attempt to connect to the hotel Wi-Fi system 506, each proximate device sends a connection request along with its unique identifier. The hotel Wi-Fi server 508 receives the connection request and checks the received unique identifier against the stored list of authorized devices (e.g., the list provided by the primary device 504 at step 526). If the received identifier from the proximate device matches an entry on the stored list, the server 508 authenticates the proximate device and grants access to the network. Steps 532-538, and in particular the automatic authentication of the proximate devices after the request to connect is transmitted by the subsequent device(s) 510, may occur without any additional input from the proximate device(s) 510. That is, the user need not input any password or other credentials via the subsequent devices.

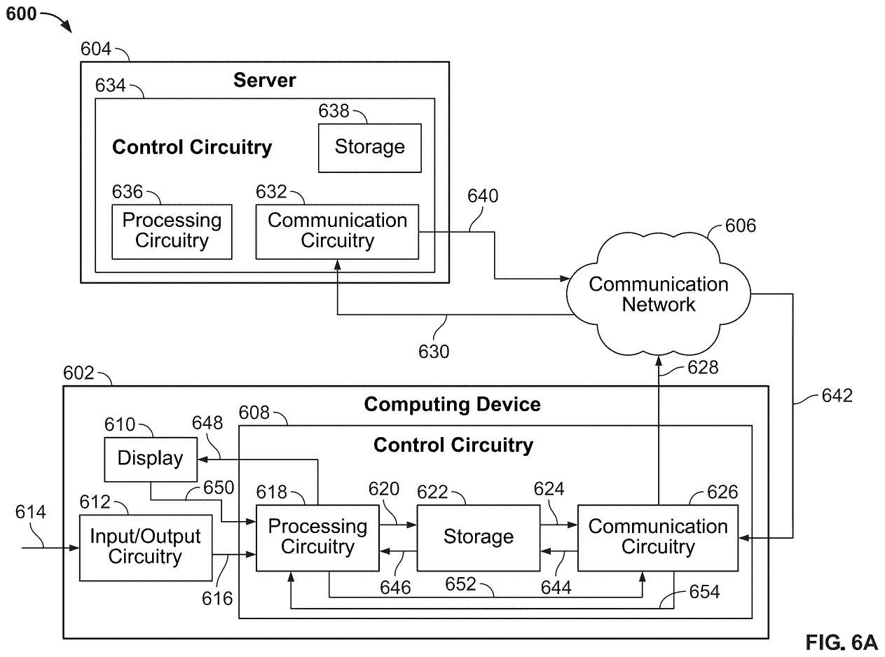

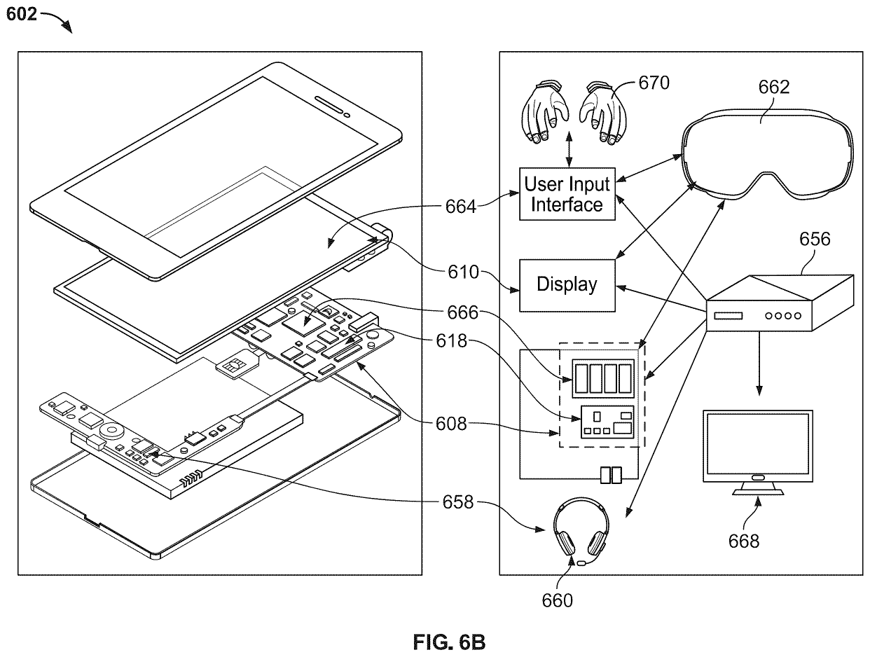

FIG. 6A depicts system 600 according to various embodiments of this disclosure. System 600 may be configured to execute the methods, systems, and functions described above and below with respect to FIGS. 1-5 and 8, and may include various implementations of processing circuitry across one or more devices to execute any or all of, in whole or in part, the methods and functions depicted in and described elsewhere in this disclosure. System 600 is shown to include a computing device 602, a server 604 and a communication network 606. It is understood that while a single instance of a component may be shown and described relative to FIG. 6, additional instances of the component may be employed. For example, server 604 may include, or may be incorporated in, more than one server. Similarly, communication network 606 may include, or may be incorporated in, more than one communication network. Server 604 is shown communicatively coupled to computing device 602 through communication network 606. While not shown in FIG. 6A, server 604 may be directly communicatively coupled to computing device 602, for example, in a system absent or bypassing communication network 606.

Communication network 606 may comprise one or more network systems, such as, without limitation, an internet, LAN, WIFI or other network systems suitable for carrying out the functions described herein. In some embodiments, system 600 excludes server 604, and functionality that would otherwise be implemented by server 604 is instead implemented by other components of system 600, such as one or more components of communication network 606. In still other embodiments, server 604 works in conjunction with one or more components of communication network 606 to implement certain functionality described herein in a distributed or cooperative manner. Similarly, in some embodiments, system 600 excludes computing device 602, and functionality that would otherwise be implemented by computing device 602 is instead implemented by other components of system 600, such as one or more components of communication network 606 or server 604 or a combination. In still other embodiments, computing device 602 works in conjunction with one or more components of communication network 606 or server 604 to implement certain functionality described herein in a distributed or cooperative manner.

Computing device 602 includes control circuitry 608, display 610 and input circuitry 612. Control circuitry 608 in turn includes communication circuitry 626, storage 622 and processing circuitry 618. In some embodiments, computing device 602 or control circuitry 608 may be configured as computing device 602 of FIG. 6B.

Server 604 includes control circuitry 634 and storage 638. Each of storages 622 and 638 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 622, 638 may be used to store various types of content, device IDs, device groups, device lists, metadata, segments of content items, user behavior, and or other types of data. Non-volatile memory may also be used (e.g., to launch a boot-up routine and other instructions). Cloud-based storage may be used to supplement storages 622, 638 or instead of storages 622, 638. In some embodiments, data characterized through a user device, a profile affiliated with a user device, or data retrievable and transmittable to a generative AI engine, and data relating to all other processes and features described herein, may be recorded and stored in one or more of storages 622, 638.

In some embodiments, control circuitry 634 and/or 608 executes instructions for an application stored in memory (e.g., storage 638 and/or storage 622). Specifically, control circuitry 634 and/or 608 may be instructed by the application to perform the functions discussed herein. In some implementations, any action performed by control circuitry 634 and/or 608 may be based on instructions received from the application. For example, the application may be implemented as software or a set of executable instructions that may be stored in storage 638 and/or 622 and executed by control circuitry 634 and/or 608. In some embodiments, the application may be a client/server application where only a client application resides on computing device 602, and a server application resides on server 604.

The application may be implemented using any suitable architecture. For example, it may be a stand-alone application wholly implemented on computing device 602. In such an approach, instructions for the application are stored locally (e.g., in storage 622), and data for use by the application is downloaded on a periodic basis (e.g., from an out-of-band feed, from an internet resource, or using another suitable approach). Control circuitry 608 may retrieve instructions for the application from storage 622 and process the instructions to perform the functionality described herein. Based on the processed instructions, control circuitry 608 may determine a type of action to perform in response to input received from input circuitry 612 or from communication network 606.

In client/server-based embodiments, control circuitry 608 may include communication circuitry suitable for communicating with an application server (e.g., server 604) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 606). In another example of a client/server-based application, control circuitry 608 runs a web browser that interprets web pages provided by a remote server (e.g., server 604). For example, the remote server may store the instructions for the application in a storage device. The remote server may process the stored instructions using circuitry (e.g., control circuitry 608) and/or generate displays. Computing device 602 may receive the displays generated by the remote server and may display the content of the displays locally via display 610. This way, the processing of the instructions is performed remotely (e.g., by server 604) while the resulting displays are provided locally on computing device 602. Computing device 602 may receive inputs from the user via input circuitry 612 and transmit those inputs to the remote server for processing and generating the corresponding displays. Alternatively, computing device 602 may receive inputs from the user via input circuitry 612 and process and display the received inputs locally, by control circuitry 608 and display 610, respectively.

Server 604 and computing device 602 may transmit and receive content and data such as device IDs, device lists, device groups, user data, and input from primary devices and secondary devices, such as speakers, LED displays or arrangements, monitors of smart home devices or audio-video device, or one or more of AR or XR devices. Control circuitry 634, 608 may send and receive commands, requests, and other suitable data through communication network 606. Control circuitry 634, 608 may communicate directly with each other using communication circuitry 626 and 632, respectively, avoiding communication network 606.

It is understood that computing device 602 is not limited to the embodiments and methods shown and described herein. In nonlimiting examples, computing device 602 may be a virtual, augmented, or mixed reality headset, smart glasses, or a device that can perform functions in the metaverse, a primary device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably displaying content items.

Control circuitry 634 and/or 608 may be based on any suitable processing circuitry such as processing circuitry 618 and/or 636, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 634 and/or control circuitry 608 are configured to render one or more elements of supplemental content corresponding to a selectable user interface element described throughout this disclosure.

User input 604 may be received from virtual, augmented, or mixed reality headsets, mobile data, smart glasses. Transmission of user input 604 to computing device 602 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G, or any other suitable wireless transmission protocol. Input circuitry 912 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 618 may receive input 604 from input circuit 612. Processing circuitry 618 may convert or translate the received user input 604 that may be in the form of voice input into a microphone, or movement or gestures to digital signals. In some embodiments, input circuit 612 performs the translation to digital signals. In some embodiments, processing circuitry 618 (or processing circuitry 636, as the case may be) carries out disclosed processes and methods.

FIG. 6B depicts computing device 602 of system 600, in accordance with some embodiments of the disclosure. Computing device 602 may be configured to execute one or more functions described herein.

Computing device 602 may be a smartphone device, a tablet, a virtual reality or augmented reality device, or any other suitable device capable of processing data and carrying out one or more functions described in this disclosure. In another example, a user equipment device, such as a user television equipment system or streaming interface device, may include media access device 656. Media access device 656 may be communicatively connected to haptic enabled headset 658, audio input equipment (e.g., headset microphone 660), and display 610. In some embodiments, display 610 may be a television display or a computer display. In some embodiments, display 610 may be a display in an HMD or an XR device. As shown in FIG. 6B, display 610 may be communicatively coupled to or may comprise head mounted display 662, which also is shown in FIG. 6B as being communicatively coupled to one or more of user input interface 664 (e.g., may display user input interface 664 with capabilities to receive user inputs via input/output circuitry 612 of FIG. 6A) or haptic feedback hand devices 670 (e.g., configured to enable a user to provide inputs to user input interface 668 or display 610 as the user would by a remote or a communicatively coupled computer mouse or joystick), while also being communicatively coupled to media access device 656. In some embodiments, user input interface 668 may be a remote-control device. Media access device 656 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Computing device 602 may receive content and data via input/output (I/O) path (e.g., circuitry) 666, which may communicatively interface with head mounted display 662. I/O path 666 may provide content (e.g., broadcast programming, on-demand programming, Internet content, content available over a local area network (LAN) or wide area network (WAN), and/or other content) and data to control circuitry 608, which may comprise processing circuitry 618 and storage 622 of FIG. 6A. Control circuitry 608 may be used to send and receive commands, requests, and other suitable data using I/O path 666, which may comprise I/O circuitry. I/O path 666 may connect control circuitry 608 (and specifically processing circuitry 618) to one or more communications paths (described below). I/O functions may be provided by one or more of these communications paths but are shown as a single path in FIG. 6B to avoid overcomplicating the drawing. While media access device 656 is shown in FIG. 6B for illustration, any suitable computing device having processing circuitry, control circuitry, and storage may be used in accordance with the present disclosure. For example, media access device 656 may be replaced by, or complemented by, a personal computer (e.g., a notebook, a laptop, a desktop), a smartphone (e.g., device 602), a tablet, a network-based server hosting a user-accessible client device, a non-user-owned device, any other suitable device, or any combination thereof.

Control circuitry 608 may be based on any suitable control circuitry such as processing circuitry 618. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 608 executes instructions for the video application stored in memory (e.g., storage 622 or 638 of FIG. 6A). Specifically, control circuitry 608 may be instructed by the application to perform the functions discussed above and below. In some implementations, processing or actions performed by control circuitry 608 may be based on instructions received from the application.

In client/server-based embodiments, control circuitry 608 may include communications circuitry suitable for communicating with a server or other networks or servers. The application described herein may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 6B, the instructions may be executed by control circuitry 608 of computing device 602 while being stored via one or more processors shown in FIG. 6A.

In some embodiments, the application may be a client/server application where a portion of the application resides on computing device 602, and a portion of the application resides on an external server (e.g., server 604 of FIG. 6A). For example, the application may be implemented partially as a client application on control circuitry 608 of computing device 602 and partially on server 604 as a server application running on control circuitry 634. Server 604 may be a part of a local area network with one or more computing devices 602 or may be part of a cloud computing environment accessed via the internet. In a cloud computing environment, various types of computing services for performing searches on the internet or informational databases, providing seamless virtual space traversing capabilities, providing storage (e.g., for a database) or parsing data (e.g., using machine learning algorithms) are provided by a collection of network-accessible computing and storage resources (e.g., server 604 and multiples of computing device 602), referred to as “the cloud.” Computing device 602 may be a cloud client that relies on the cloud computing capabilities from server 604 to determine whether processing (e.g., at least a portion of virtual background processing and/or at least a portion of other processing tasks) should be offloaded from the mobile device and facilitate such offloading. When executed by control circuitry of server 604, the application may instruct control circuitry 634 or 608 to perform processing tasks for the client device and facilitate the seamless virtual space traversing.

Control circuitry 608 may include communications circuitry suitable for communicating with a server, edge computing systems and devices, a table or database server, or other networks or servers. The instructions for carrying out the above-mentioned functionality may be stored on a server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device that is part of control circuitry 608. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. The storage may be used to store various types of content described herein as well as application data described above. Nonvolatile memory may also be used (e.g., to launch a boot-up routine and other instructions). Cloud-based storage may also be used to supplement storage 638 of FIG. 6A or instead of storage 622.

Control circuitry 608 may include video generating circuitry and tuning circuitry, such as one or more analog tuners, one or more video decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 608 may also include scaler circuitry for up converting and down converting content into the preferred output format of computing device 602. Control circuitry 608 may also include digital-to-analog converter circuitry and analog-to-digital converter circuitry for converting between digital and analog signals. The tuning and encoding circuitry may be used by computing device 602 to receive and to display, to play, or to record content. The tuning and encoding circuitry may also be used to receive video data for seamless interspace traversing. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage is provided as a separate device from computing device 602, the tuning and encoding circuitry (including multiple tuners) may be associated with the storage.

Control circuitry 608 may receive instruction from a user by way of user input interface 664. User input interface 664 may be any suitable user interface, such as a remote control, mouse, trackball, keypad, keyboard, touch screen, touchpad, stylus input, joystick, voice recognition interface, or other user input interfaces (e.g., an interface configured to receive inputs from haptic feedback hand devices 670). Display 610 may be provided as a stand-alone device or integrated with other elements of each one of computing device 602. For example, display 610 may be a touchscreen or touch-sensitive display. In such circumstances, user input interface 664 may be integrated with or combined with display 610 (e.g., where haptic feedback hand devices 670 is configured to enable a user to interact with or manipulate aspects of a user interface displayed via head mounted display 662). In some embodiments, user input interface 664 includes a remote-control device having one or more microphones, buttons, keypads, and any other components configured to receive user input or combinations thereof. For example, user input interface 664 may include a handheld remote-control device having an alphanumeric keypad and option buttons (e.g., haptic feedback hand devices 670). In a further example, user input interface 664 may include a handheld remote-control device having a microphone and control circuitry configured to receive and identify voice commands and transmit information to media access device 656.

Headset microphone 660 may be integrated with or combined with display 610. Display 610 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 610. Headset microphone 660 may be provided as integrated with other elements of each one of computing device 602 or may be stand-alone units. An audio component of videos and other content displayed on display 610 may be played through speakers (or headphones) of haptic enabled headset 658. In some embodiments, audio may be distributed to a receiver (not shown), which processes and outputs the audio via speakers of haptic enabled headset 658. In some embodiments, for example, control circuitry 608 is configured to provide audio cues to a user, or other audio feedback to a user, using speakers of haptic enabled headset 658. There may be a separate haptic enabled headset 658 or headset microphone 660 may include a microphone configured to receive audio input such as voice commands or speech. For example, a user may speak letters or words that are received by the microphone and converted to text by control circuitry 608. In a further example, a user may voice commands that are received by a microphone and recognized by control circuitry 608. Recording device 668 may be any suitable video camera integrated with the equipment or externally connected. Recording device 668 may be a digital camera comprising a charge-coupled device (CCD) and/or a complementary metal-oxide semiconductor (CMOS) image sensor. Recording device 668 may be an analog camera that converts to digital images via a video card.

The application configured to perform the functions described herein may be implemented using any suitable architecture. For example, it may be a stand-alone application wholly implemented on each one of computing device 602. In such an approach, instructions of the application may be stored locally, and data for use by the application is downloaded on a periodic basis (e.g., from an out-of-band feed, from an Internet resource, or using another suitable approach). Control circuitry 608 may retrieve instructions of the application from storage and process the instructions to provide seamless interspace traversing functionality and perform any of the actions discussed herein. Based on the processed instructions, control circuitry 608 may determine what action to perform when input is received from user input interface 664. For example, movement of a cursor on a display up/down may be indicated by the processed instructions when user input interface 664 indicates that an up/down button was selected (e.g., based on inputs provided via haptic feedback hand devices 670). An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the application is a client/server-based application. Data for use by a thick or thin client implemented on each one of computing device 602 and may be retrieved on-demand by issuing requests to a server remote to each one of computing device 602. For example, the remote server may store the instructions for the application in a storage device. The remote server may process the stored instructions using circuitry (e.g., control circuitry 608) and generate the displays discussed above and below. The client device may receive the displays generated by the remote server and may display the content of the displays locally on computing device 602. This way, the processing of the instructions is performed remotely by the server while the resulting displays (e.g., that may include text, a keyboard, or other visuals) are provided locally on computing device 602. Computing device 602 may receive inputs from the user via input interface 664 and transmit those inputs to the remote server for processing and generating the corresponding displays. For example, computing device 602 may transmit a communication to the remote server indicating that an up/down button was selected via input interface 664 (e.g., based on one or more inputs provided via one or more of haptic feedback hand devices 670 or head mounted display 662). The remote server may process instructions in accordance with that input and generate a display of the application corresponding to the input (e.g., a display that moves a cursor up/down). The generated display is then transmitted to a communicatively accessible device for presentation to the user.

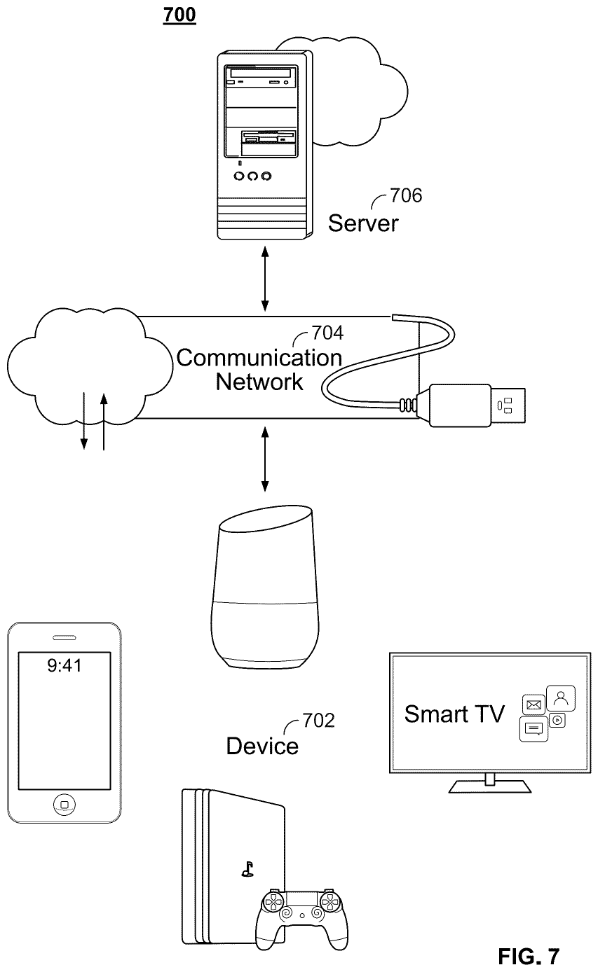

As depicted in FIG. 7, device 702 may be coupled to communication network 704. Communication network 704 may be one or more networks including the internet, a mobile phone network, mobile voice or data network (e.g., a 4G or LTE network), cable network, public switched telephone network, Bluetooth, or other types of communication network or combinations of communication networks. Thus, device 702 may communicate with server 706 over communication network 704 via communications circuitry described above. It should be noted that there may be more than one server 706, but only one is shown in FIG. 7 to avoid overcomplicating the drawing. The arrows connecting the respective device(s) and server(s) represent communication paths, which may include a satellite path, a fiber-optic path, a cable path, a path that supports internet communications (e.g., IPTV), free-space connections (e.g., for broadcast or other wireless signals), or any other suitable wired or wireless communications path or combination of such paths.

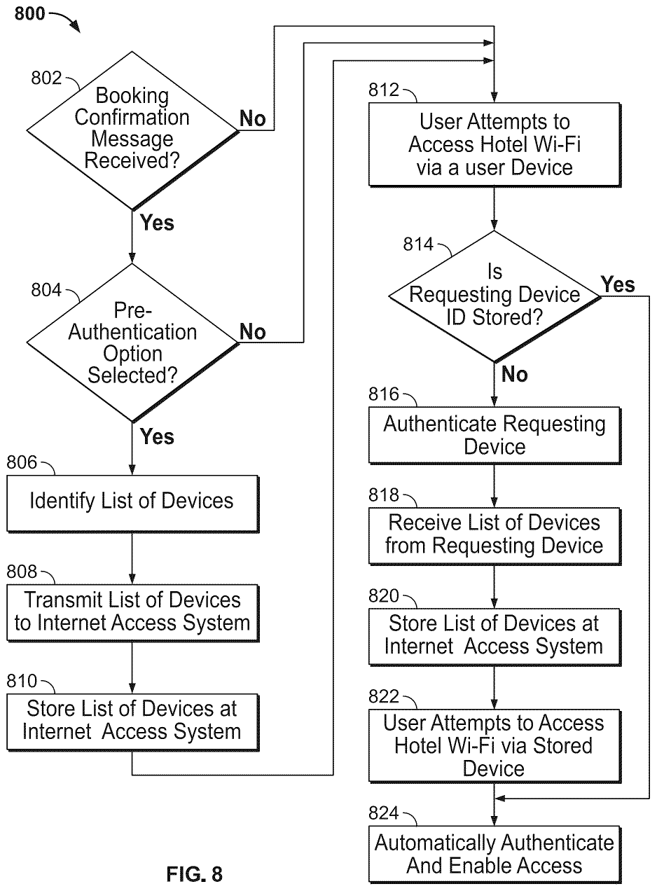

FIG. 8 is an example flowchart of a process 800 for automatically authenticating one or more secondary devices after authenticating a primary device, in accordance with some examples of the disclosure. The process 800 may be carried out by the devices and/or systems described herein, and/or may be implemented, in whole or in part, by the devices and systems shown in FIGS. 1-7. One or more actions of the process 800 may be incorporated into or combined with one or more actions of any other process or embodiments described herein. The process 800 may be saved to a memory or storage (such as any one or more of those shown in FIGS. 6A-6B) as one or more instructions or routines that may be executed by a corresponding device or system to implement the process 800.

At step 802, the process 800 includes determining whether a booking confirmation message has been received. The booking confirmation message may be received by the user's primary device (e.g., the device which they will most likely bring to the hotel) or may be received by another of the user's devices such as a work or home computer. If the booking confirmation email has been received at step 802, the process 800 proceeds to step 804 at which the process includes determining whether the pre-authentication user interface element has been selected. This may include the user selecting the option to pre-authenticate one or more devices via the booking confirmation message.

At step 806, the process 800 includes identifying a list of the user's devices. This may include presenting a prompt or user interface vie the user's device, and enabling the user to select one or more devices, device groups, networks (e.g., each network may correspond to a device group that was established via that network), or some other set of devices. At step 808, the process includes the user's device transmitting the list of devices to the internet access system associated with the booking confirmation message (e.g., the hotel Wi-Fi system). Then at step 810, the list of devices is stored at the internet access system. This may include storing the unique device IDs and/or the human-readable name of each device on the list of devices identified at step 806.

At step 812, the process 800 includes the user attempting to access the internet access system (e.g., the hotel Wi-Fi) via a first device. This device may be the same device that received the booking confirmation message and was used to perform the pre-authentication, or it may be a different device of the user.

At step 814, the process includes the internet access system of the hotel determining whether the device requesting access at step 812 is stored already by the internet access system. If the requesting device ID is already stored, that indicates that the requesting device has already been pre-authenticated, and the process proceeds to step 824 at which the device is authenticated and access to the internet via the internet access system is enabled.

If the requesting device is not stored already by the internet access system (e.g., no pre-authentication was performed, and this is the first device of the user attempting to access the internet access system), then the process proceeds to step 816. At step 816, the internet access system performs an authentication of the requesting device. This may include having the requesting device provide a password or other credential.

At step 818, once the requesting device is authenticated, the internet access system may receive a list of devices from the requesting device. The list of devices may comprise the rest of the user's devices for which automatic authentication is desired. For example, if the requesting device is the user's personal phone, the list of devices may include the user's work phone, laptop, smart watch, etc.

At step 820, the list of devices (e.g., the unique IDs and/or human-readable names of the user's devices) is stored by the internet access system. In some examples, the list of devices is provided directly by the requesting device. In other examples, the list of devices may be retrieved from a cloud storage (e.g., as described above with respect to FIG. 2).

At step 822, the user may then attempt to access the internet access system using one or more of the user's other devices which were included in the list of devices stored at step 820.

The internet access system may compare the received device ID from the one or more other devices, and if the received ID matches a stored device ID, the internet access system may automatically authenticate the other device and enable access to the internet access system.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

Each feature disclosed in this specification (including any accompanying claims, abstract, and drawings), may be replaced by alternative features serving the same, equivalent, or similar purpose unless expressly stated otherwise. Thus, unless expressly stated otherwise, each feature disclosed is one example only of a generic series of equivalent or similar features.

The invention(s) are not restricted to the details of any foregoing embodiments. The invention(s) extend to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract, and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method comprising:
authenticating, by an internet access system, a first device of a plurality of devices;
receiving, by the internet access system, from the first device of the plurality of devices, a device list comprising a respective device ID for each of the plurality of devices; and
based at least in part on the internet access system receiving a request to access the internet access system from a second device of the plurality of devices, automatically authenticating the second device with the internet access system using the received device list before receiving additional input from the second device.

2. The method of claim 1, wherein the plurality of devices comprises a device group, the method further comprising:
establishing the device group based on detecting that the plurality of devices are all connected to the same communication network.

3. The method of claim 1, wherein the plurality of devices comprises a device group, the method further comprising:
causing to be presented via a user interface of the first device, a prompt enabling selection of one or more selected devices; and
establishing the device group based on the selection of the one or more selected devices.

4. The method of claim 1, further comprising storing the device list in a cloud storage.

5. The method of claim 1, further comprising:
after authenticating the first device of the plurality of devices with the internet access system, causing to be provided via a user interface of the first device, a prompt enabling selection of the second device of the plurality of devices; and
based on receiving the selection of the second device of the plurality of devices, storing, at the internet access system, the device ID of the second device.

6. The method of claim 5, further comprising:
based on receiving the selection of the second device of the plurality of devices, automatically authenticating the second device with the internet access system before receiving additional input from the second device.

7. The method of claim 1, further comprising:
after authenticating the first device of the plurality of devices with the internet access system, determining the second device based on short range wireless communication between the first device and the second device; and
based on the short range wireless communication between the first device and the second device, storing, at the internet access system, the device ID of the second device.

8. The method of claim 1, wherein the plurality of devices comprises a first device group, the method further comprising:
causing to be provided via a user interface of the first device, a prompt enabling selection of a second device group of a plurality of device groups; and
based on receiving the selection of the second device group, storing, at the internet access system, the respective device IDs of each device of the second device group.

9. The method of claim 1, further comprising:
before authenticating the first device, transmitting a message associated with the internet access system to the first device, the message comprising a selectable option to pre-authenticate a connection of the first device to the internet access system; and
pre-authenticating the first device of the plurality of devices with the internet access system based on receiving a selection of the selectable option.

10. The method of claim 9, wherein the message comprises a booking confirmation email corresponding to a future period of time for which a user associated with the first device is booked to stay at a temporary lodging, wherein the method further comprises:
based on receiving the selection of the selectable option, storing the device ID corresponding to the first device by the internet access system.

11. The method of claim 9, further comprising:
identifying an authentication period based on the message, wherein the authentication period corresponds to a future time period for which a user associated with the first device is booked to stay at a temporary lodging associated with the internet access system; and
based on receiving the selection of the selectable option, pre-authenticating the first device of the device group with the internet access system such that the first device is enabled to access the internet access system at a beginning of the authentication period, and is disabled from accessing the internet access system at an end of the authentication period.

12. The method of claim 1, further comprising:
storing the device list comprising the respective device IDs of all of the plurality of devices in an encrypted format.

13. A system comprising:
control circuitry configured to:
authenticate, by an internet access system, a first device of a plurality of devices; and input/output circuitry configured to:
receive, by the internet access system, from the first device of the plurality of devices, a device list comprising a respective device ID for each of the plurality of devices; and
wherein the control circuitry is further configured to:
based at least in part on the internet access system receiving a request to access the internet access system from a second device of the plurality of devices, automatically authenticate the second device with the internet access system using the received device list before receiving additional input from the second device.

14. The system of claim 13, wherein the plurality of devices comprises a device group, and wherein the control circuity is further configured to:
establish the device group based on detecting that the plurality of devices are all connected to the same communication network.

15. The system of claim 13, wherein the plurality of devices comprises a device group, and wherein the control circuitry is further configured to:
cause to be presented via a user interface of the first device, a prompt enabling selection of one or more selected devices; and
establish the device group based on the selection of the one or more selected devices.

16. The system of claim 13, wherein the control circuitry is further configured to store the device list in a cloud storage.

17. The system of claim 13, wherein the control circuity is further configured to:
after authenticating the first device of the plurality of devices with the internet access system, cause to be provided via a user interface of the first device, a prompt enabling selection of the second device of the plurality of devices; and
based on receiving the selection of the second device of the plurality of devices, store, at the internet access system, the device ID of the second device.

18. The system of claim 17, wherein the control circuitry is further configured to:
based on receiving the selection of the second device of the plurality of devices, automatically authenticate the second device with the internet access system before receiving additional input from the second device.

19. The system of claim 13, wherein the control circuitry is further configured to:
after authenticating the first device of the plurality of devices with the internet access system, determine the second device based on short range wireless communication between the first device and the second device; and
based on the short range wireless communication between the first device and the second device, store, at the internet access system, the device ID of the second device.

20. The system of claim 13, wherein the plurality of devices comprises a first device group, and wherein the control circuitry is further configured to:
cause to be provided via a user interface of the first device, a prompt enabling selection of a second device group of a plurality of device groups; and
based on receiving the selection of the second device group, store, at the internet access system, the respective device IDs of each device of the second device group.

21-60. (canceled)
